(19) United States
(12) Patent Application Publication
(10) Pub. No.: US 2013/0010143 A1
(43) Pub. Date: Jan. 10, 2013

(54) IMAGING ASSEMBLY FOR MARINE USE

(75) Inventor: Jared S. Phillips, Jerseyville, IL (US)

(73) Assignee: MIKE'S INC., South Roxana, IL (US)

(21) Appl. No.: 13/177,312

(22) Filed: Jul. 6, 2011

(51) Int. Cl. H04N 5/225

(52) U.S. Cl. 348/216.1; 348/E05.024

(57) ABSTRACT

An imaging assembly for marine use. The imaging assembly includes a stand having a magnetic base adapted for releasably attaching the stand to a vessel. In use, the stand extending upward from the base to an upper portion. The assembly includes a night vision imaging device mounted on the stand for imaging a selected field of view and a power source mounted on the stand and operatively connected to the imaging device for providing power to the imaging device. The imaging assembly also includes a transmitter mounted on the stand and operatively connected to the imaging device for transmitting a signal corresponding to the selected field of view to a remote location.

### FIELD OF THE INVENTION

The present invention generally relates to imaging assemblies for marine use, and more particularly to an imaging assembly for serial use on different selected vessels.

### BACKGROUND OF THE INVENTION

Imaging assemblies on marine vessels have been used to aid in navigation and enhance a vessel pilot's vision. A towboat pilot must be able to see ahead of barges the towboat is pushing to effectively navigate and avoid obstacles. A typical tow may include a group of fifteen barges lined up five deep and three across. The towboat pushes the tow from behind, making it difficult for the pilot to see in front of the lead barge, which may be more than five barge lengths away from the wheelhouse where the pilot is located. This viewing problem is even more difficult to overcome at night. Lights and night vision systems have been used to assist the towboat pilot at night.

Conventional marine night vision systems are permanently mounted on a vessel. When used on a tow, the night vision system is most effective mounted at the forward end of the tow where the system has an optimal view ahead of the tow. Because it would be expensive to provide night vision systems on every barge, only lead barges are provided with night vision systems. The barges having night vision equipment, however, must be separately tracked to ensure they are positioned at the front of the tow. Further, because a barge having night vision equipment is not always available, tows must sometimes be dispatched without night vision systems thereby defeating the advantages of having systems. In order to overcome these problems, it is envisioned that imaging systems could be mounted on the towboat rather than the lead barge. Mounting the imaging systems on the towboat reduces their effectiveness to aid navigation because they are removed from the forward end of the tow where they have the best view ahead of the tow. Thus, there is a need for imaging systems that overcome these problems inherent in existing imaging systems used on tows and other commercial vessels.

### SUMMARY OF THE INVENTION

In one aspect, the present invention includes an imaging assembly for marine use. The imaging assembly comprises a stand having a magnetic base adapted for releasably attaching the stand to a vessel. The stand in use extends upward from the base to an upper portion. The imaging assembly also includes a night vision imaging device mounted on the stand for imaging a selected field of view. Further, the imaging assembly comprises a power source mounted on the stand and operatively connected to the imaging device for providing power to the imaging device. The imaging assembly includes a transmitter mounted on the stand and operatively connected to the imaging device for transmitting a signal corresponding to the selected field of view to a remote location.

In another aspect, the present invention includes a night vision system for marine use. The night vision system comprises a self-contained portable imaging assembly. The imaging assembly includes a stand having a magnetic base adapted for releasably attaching the stand to a vessel. The stand in use extends upward from the base to an upper portion. The imaging assembly also includes a night vision camera mounted on the stand for imaging a selected field of view. Further, the imaging assembly comprises a power source operatively connected to the night vision camera for powering the night vision camera and a wireless transmitter operatively connected to the night vision camera for wirelessly transmitting a signal corresponding to the selected field of view. In addition, the night vision system comprises a receiver positionable in a location remote from the imaging assembly adapted to receive the wirelessly transmitted signal from the wireless transmitter and a display operatively connected to the receiver for displaying images corresponding to the selected field of view.

In still another aspect, the present invention includes a method of using a portable imaging assembly in a marine environment. The method comprises mounting a magnetic stand including a power source, a wireless transmitter, and a night vision camera on a lead barge of an initial tow. Images are transmitted from the night vision camera through the wireless transmitter to a wheelhouse on a towboat driving the initial tow to aid navigation. The method further includes removing the magnetic stand from the lead barge of the initial tow, and mounting the magnetic stand on a lead barge of a subsequent tow for transmitting images to a wheelhouse of a towboat driving the subsequent tow to aid navigation.

Other objects and features will be in part apparent and in part pointed out hereinafter.

### BRIEF DESCRIPTION OF THE DRAWINGS

FIG. 1 is a schematic illustration of an imaging system according to the present invention in use on a tow;

FIG. 2 is a perspective of an imaging assembly of the present invention;

FIG. 3 is a fragmentary and partially sectioned view of the imaging assembly, illustrating an upper portion thereof;

FIG. 4 is a fragmentary view of the imaging assembly, illustrating a lower portion thereof; and

FIG. 5 is a perspective of a receiver and display for use with the present invention.

Corresponding reference characters indicate corresponding parts throughout the drawings.

### DESCRIPTION OF THE PREFERRED EMBODIMENTS

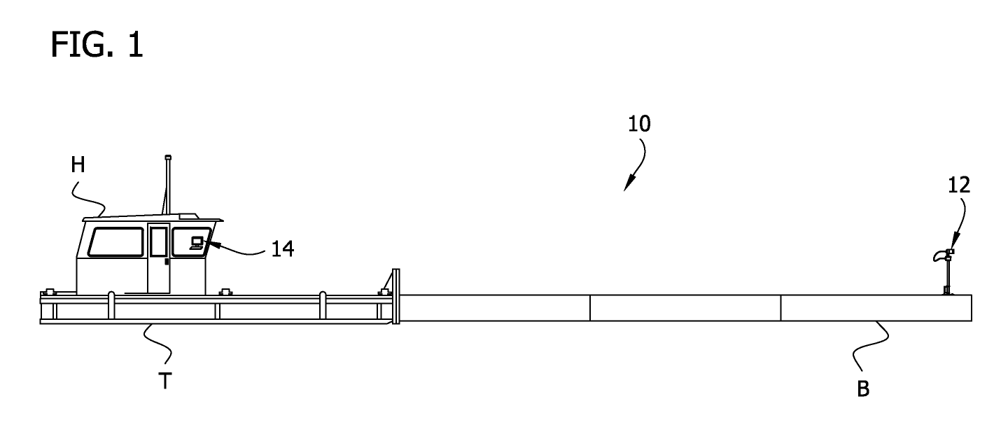

Referring to the drawings and in particular to FIG. 1, an imaging system for marine use is generally designated in its entirety by the numeral 10. The system 10 generally includes an imaging assembly (generally designated by 12) and a viewing assembly (generally designated by 14). Although the system 10 may be used on many types of marine vessels, the imaging assembly 12 is particularly suited to be mounted at a forward end of a lead barge B of a tow and the viewing assembly 14 is suited to be located in a wheelhouse H of a towboat T pushing the tow. When used on this type of marine vessel, the system 10 enhances a pilot's vision and aids navigation, particularly night time navigation.

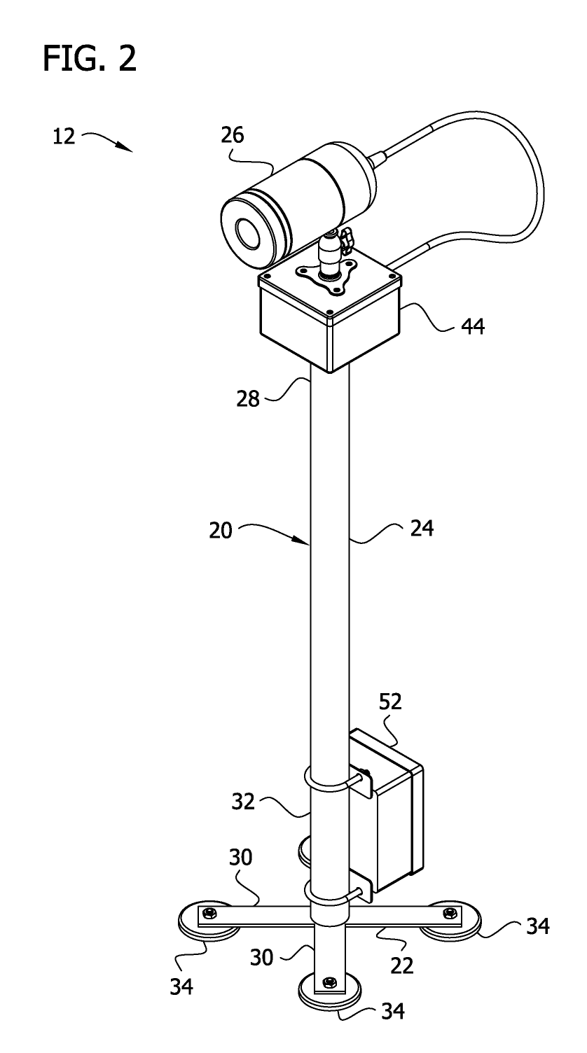

As illustrated in FIG. 2, the imaging assembly 12 generally includes a stand (generally designated by 20) having a magnetic base 22, a tubular body 24 extending upward from the base, and an imaging device 26 mounted on an upper portion 28 of the body. The magnetic base 22 is adapted for releasably attaching the stand 20 to steel decking of a vessel, such as the lead barge B shown in FIG. 1. Although the base 22 may have other configurations without departing from the scope of the present invention, in one embodiment the base has four equal spaced legs 30 extending radially outward from a lower end 32 the stand 20. Each leg 30 has a magnetic foot 34 mounted at its outboard end for holding the base 22 on the steel decking of the barge B. Although the feet 34 may be made from other types of magnets without departing from the scope of the present invention, in one embodiment each of the magnets is a conventional permanent magnet having a diameter of about five inches and a holding strength of about 200 pounds.

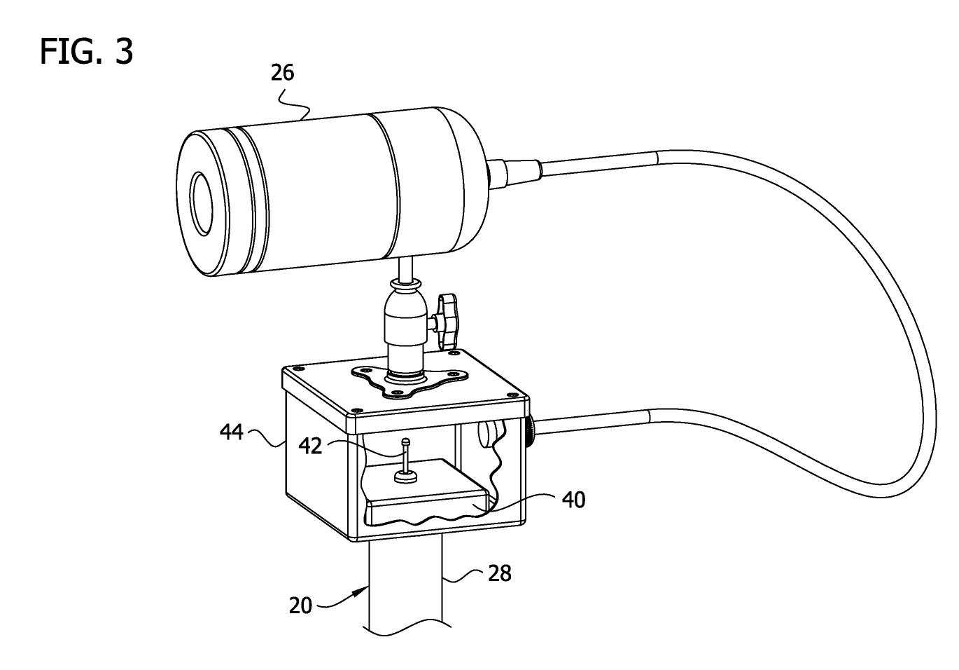

As illustrated in FIG. 3, in one embodiment the imaging device 26 is mounted on the upper portion 28 of the stand 20 to provide a selected field of view. Although the imaging device 26 may be mounted at a wide range of heights without departing from the scope of the present invention, in one embodiment the imaging device is mounted at a height so its main lens is about 56 inches from the bottom of the base 32 to provide an adequate and substantially unobstructed field of view. Although the imaging device 26 may comprise other camera types without departing from the scope of the present invention in one embodiment the camera is a night vision imaging device, such as a SC1717-1 SEE Cannon ultra-low lux camera available from Nite to Day Camera Systems of Flower Mound, Tex. It is envisioned that other types of cameras, such as thermal imaging cameras may be used instead of or to supplement the night vision imaging device described above. Due to the environment, the imaging device 26 is preferably watertight or mounted in a transparent watertight compartment (not shown).

As further shown in FIG. 3, a transmitter 40 having an antenna 42 is operatively connected to the imaging device 26 for transmitting a signal corresponding to the selected field of view as imaged by the imaging device 26. Although the transmitter 40 may be of other types, in one embodiment the transmitter is a T-5808 transmitter available from VideoComm Technologies of Niagara Falls, N.Y. A watertight upper housing 44 is provided on the upper portion 28 of the stand for holding the transmitter 40. The upper housing 44 is preferably watertight to protect the transmitter 40 from potential water damage. The upper housing 44 is positioned high on the stand 20 to provide a higher position for the antenna 42 so the transmitter 40 can send a low power signal farther. Although the upper housing 44 may be made of other materials without departing from the scope of the present invention, in one embodiment the housing is made of a plastic material.

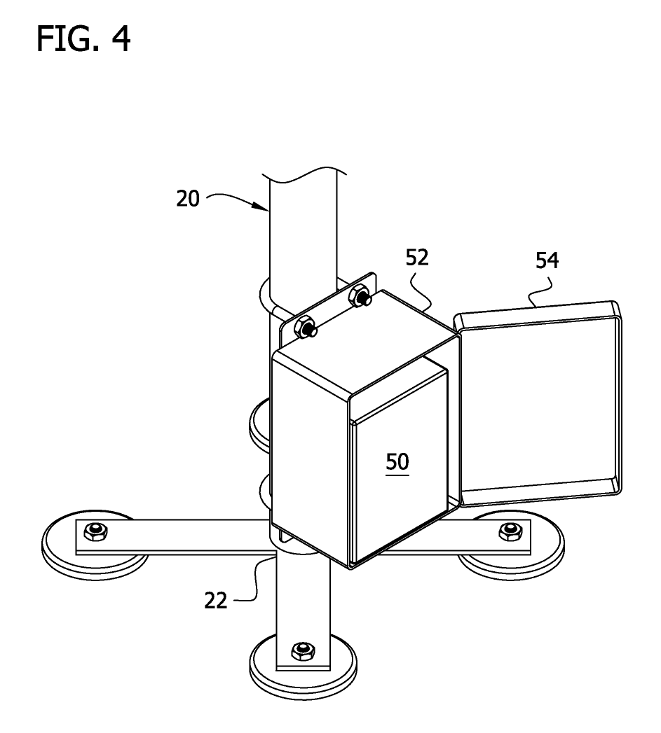

As illustrated in FIG. 4, a power source 50 is operatively connected to imaging device 26 to supply electric power to the imaging device. In some embodiments, the power source 50 is a Werker rechargeable twelve volt battery available from Batteries Plus, LLC of Hartland, Wis. As shown in FIG. 4, the power source 50 is enclosed in a watertight lower housing 52 mounted on the stand 20 adjacent the base 22. The lower housing 52 is positioned low on the stand 20 because battery power sources of the type used in the preferred embodiment are relatively heavy. Positioning the power source 50 low on the stand 20, lowers the center of gravity of the imaging assembly 12, making it less likely to tip over as the vessel rocks in the water. Although the lower housing 52 may be made of other materials without departing from the scope of the present invention, in one embodiment the housing is made of steel. The lower housing 52 is preferably watertight to protect the power source 50 from damage that might otherwise occur in a marine environment. In one embodiment, the lower housing 52 includes a watertight door 54 for accessing the power source 50 for charging or replacement.

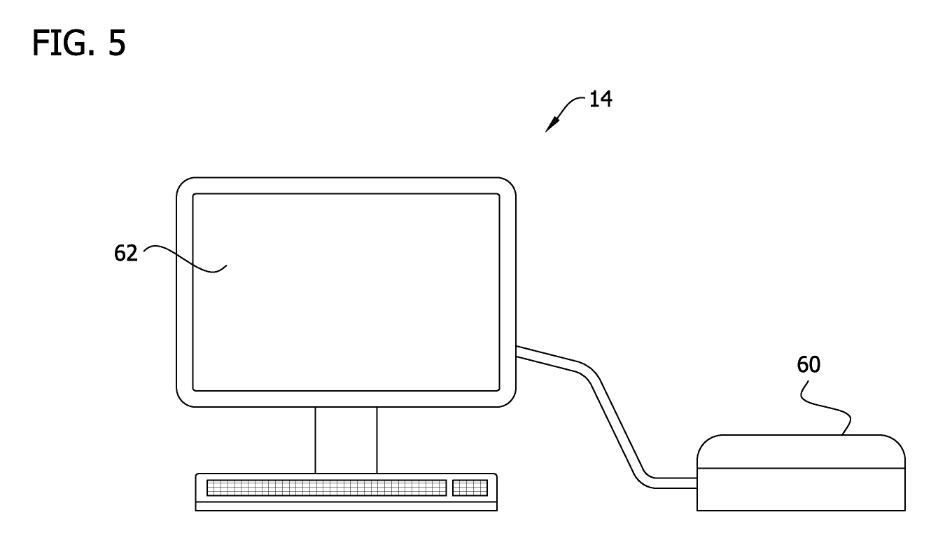

As shown in FIG. 5, the viewing assembly 14 generally includes a receiver 60 and a display 62, both of which are located remote from the transmitter 40. For example, in one embodiment the viewing assembly 14 is mounted in the wheelhouse H of the towboat T where it can be seen by a pilot piloting the towboat. The receiver 60 is operatively matched to the transmitter 40 for receiving the signal transmitted by the transmitter. Although other types of receivers may be used without departing from the scope of the present invention, in one embodiment the receiver 60 is a RCT-5808 receiver available from VideoComm Technologies of Niagara Falls, N.Y. The display 62 is a conventional display such as a DIB-19 light emitting diode monitor available from Big Bay Technologies Inc. of Seattle, Wash.

In use, the stand 20 is temporarily mounted on the lead barge B of an initial or first tow. Images are transmitted from the imaging device 26 through the transmitter 40 to the wheelhouse H of a towboat T driving the initial tow. Preferably, the images are transmitted to the wheelhouse receiver 60 and shown on the display 62 continuously throughout an entire work shift of an initial tow pilot, or more specifically for at least about 8-12 hours. After the work shift of the initial tow pilot or when needed, the power source 50 can be recharged. Because the stand 20 is portable, the power source 50 need not be removed from its housing 52. The stand may be removed from the barge B to a recharging station (not shown). Alternatively, the power source 50 may be removed from the housing 52 and carried to the charging station.

When the imaging system 10 is needed on another tow, the imaging assembly 12 can be removed from the lead barge B of the initial tow, carried to a new tow and mounted on its lead barge. Because the viewing assembly 14 is needed in every wheelhouse H, it need not be moved and may be permanently mounted in the wheelhouse H. As will be appreciated by those skilled in the art, the materials used to make the stand 20 make it light weight to improve the transportability of the imaging assembly 12. Further, because all of the equipment is watertight or positioned in watertight housings, the imaging assembly 12 is less susceptible to damage due to water present in the marine environment.

An imaging assembly 12 according to the present invention provides images to a towboat pilot to aid navigation. The imaging assembly 12 has the additional advantage of being self-contained and portable, so the assembly can be removed from an initial tow and mounted to a subsequent or second tow to aid navigation of the subsequent tow. As mentioned above, the imaging assembly 12 preferably includes a rechargeable battery power source that provides power for one or more work shifts of a towboat pilot. The power source 50 is recharged after an initial or first work shift, and then provides power for a subsequent or second work shift. As described above, the imaging assembly 12 is relatively lightweight, and in one embodiment weighs less than about ten pounds so it is easily transported from vessel to vessel by barge workers. Thus, the assembly 10 can easily be moved between vessels, thereby eliminating the need for multiple imaging assemblies for different lead barges.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. An imaging assembly for marine use, the imaging assembly comprising:
a stand having a magnetic base adapted for releasably attaching the stand to a vessel, the stand in use extending upward from the base to an upper portion;
a night vision imaging device mounted on the stand for imaging a selected field of view;
a power source mounted on the stand and operatively connected to the imaging device for providing power to the imaging device; and
a transmitter mounted on the stand and operatively connected to the imaging device for transmitting a signal corresponding to the selected field of view to a remote location.

2. An imaging assembly as set forth in claim 1, wherein the magnetic base comprises a permanent magnet.

3. An imaging assembly as set forth in claim 1, wherein the power source comprises a rechargeable battery.

4. An imaging assembly as set forth in claim 3, wherein the battery is mounted on the stand adjacent the base.

5. An imaging assembly as set forth in claim 1, wherein the transmitter comprises an antenna mounted on the upper portion of the stand.

6. An imaging assembly as set forth in claim 1, wherein the night vision imaging device is mounted on the upper portion of the stand.

7. An imaging assembly as set forth in claim 1, further comprising a lower housing mounted on the stand adjacent the base for housing the power source.

8. An imaging assembly as set forth in claim 1, further comprising an upper housing mounted on the upper portion of the stand for housing the transmitter.

9. An imaging system for marine use, the imaging system comprising:
a self-contained portable imaging assembly including:
a stand having a magnetic base adapted for releasably attaching the stand to a vessel, the stand in use extending upward from the base to an upper portion;
a night vision camera mounted on the stand for imaging a selected field of view;
a power source operatively connected to the night vision camera for powering the night vision camera; and
a wireless transmitter operatively connected to the night vision camera for wirelessly transmitting a signal corresponding to the selected field of view;
a receiver positionable in a location remote from said imaging assembly adapted to receive the wirelessly transmitted signal from the wireless transmitter; and
a display operatively connected to the receiver for displaying images corresponding to the selected field of view.

10. An imaging system as set forth in claim 9, wherein the portable imaging assembly is watertight.

11. An imaging system as set forth in claim 9, wherein the portable imaging assembly weighs less than about ten pounds.

12. An imaging system as set forth in claim 9, wherein the power source comprises a rechargeable battery.

13. An imaging system as set forth in claim 9, wherein the portable imaging assembly further comprises a lower housing mounted on the stand adjacent the base for housing the power source.

14. An imaging system as set forth in claim 13, wherein the portable imaging assembly further comprises an upper housing mounted on the upper portion of the stand for housing the transmitter.

15. An imaging system as set forth in claim 9, wherein the magnetic base comprises a permanent magnet.

16. An imaging system as set forth in claim 9, wherein the night vision camera is mounted on the upper portion of the stand.

17. A method of using a portable imaging assembly in a marine environment, the method comprising:
mounting a magnetic stand including a power source, a wireless transmitter, and a night vision camera on a lead barge of an initial tow;
transmitting images from the night vision camera through the wireless transmitter to a wheelhouse on a towboat driving the initial tow to aid navigation;
removing the magnetic stand from the lead barge of the initial tow; and
mounting the magnetic stand on a lead barge of a subsequent tow for transmitting images to a wheelhouse of a towboat driving the subsequent tow to aid navigation.

18. A method of using a portable imaging assembly as set forth in claim 17 wherein the step of transmitting images includes continuously transmitting the images for an entire work shift of an initial tow pilot.

19. A method of using a portable imaging assembly as set forth in claim 18 further comprising recharging the power source before a work shift of a subsequent tow pilot.
